(19) United States
(12) Patent Application Publication
(10) Pub. No.: US 2010/0101539 A1
(43) Pub. Date: Apr. 29, 2010

(54) HIGH-PRESSURE PUMP FOR DELIVERING FUEL COMPRISING A TORSION-DECOUPLED COMPRESSION SPRING ELEMENT IN THE PLUNGER UNIT

(76) Inventors: Gerhard Meier, Schorndorf (DE); Bernd Haeusser, Neckarwestheim (DE); Andreas Dutt, Stuttgart (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/531,642

(22) PCT Filed: Jan. 28, 2008
(86) PCT No.: PCT/EP2008/050915

§ 371 Date: Dec. 16, 2009

(30) Foreign Application Priority Data
Mar. 16, 2007 (DE) 10 2007 012 705.9

(51) Int. Cl. F02M 59/10; F02M 59/44

(52) U.S. Cl. 123/508; 417/364

(57) ABSTRACT

The invention relates to a high-pressure pump, especially for delivering fuel for a common rail fuel injection system. The pump includes at least one cam drive having a feeler element which can be set moving in direction of a stroke axis by a cam geometry introduced into the camshaft, the stroke movement being transmittable to a plunger unit. The plunger unit and the feeler element are impinged upon with a force by a compression spring element in the direction of the cam geometry and the plunger unit has at least one contact surface which adjoins the compression spring element. The at least one contact surface and/or the surface of the compression spring element adjoining the same has a friction-reduced surface coating to bring about a torsion decoupling of the compression spring element.

The present invention relates to a high-pressure pump, in particular for delivering fuel for a common rail fuel injection system of the type defined in greater detail in the preamble to claim 1.

### PRIOR ART

High-pressure pumps for delivering fuel, which are used for common rail fuel injection systems, are generally known. The high-pressure pumps serve to prepare a highly pressurized fuel inside the common rail, which is acted on with operating pressures of up to 2 Kbar and more. Consequently, the high-pressure pumps must meet particular standards for bringing the fuel to the above-mentioned pressures in an efficient manner. The high-pressure pumps are usually driven via a coupling to the crankshaft of the internal combustion engine; the high-pressure pump can be designed in accordance with the principle of a cam mechanism. Cam mechanisms of this kind include a camshaft with a cam geometry that sets a feeler element into a reciprocating motion in the direction of a stroke axis, thus producing a reciprocating motion of a pump piston connected to the feeler element. A valve mechanism incorporated into a cylinder head makes it possible for the pump piston to cooperate with the cylinder head in order to deliver the fuel. The pump piston is guided in a reciprocating fashion in the pump body or the cylinder head and remains connected to the feeler element at least by means of a roller shoe. The feeler element is usually embodied in the form of a roller that rolls along the cam geometry. The arrangement of the roller operatively connected to the cam geometry is advantageous because it produces a linear contact with a high bearing capacity between the roller and the cam geometry. In addition, only rolling motions occur, which are wear-minimized in comparison to sliding motions. In order to guide the feeler element embodied in the form of a roller against the cam geometry, it is pressed against the latter by means of a compression spring element, which simultaneously assures the return stroke of the pump piston. Compression spring elements of this kind are embodied in the form of spiral springs and extend between a collar inside the cylinder head and the so-called roller shoe in which the roller is accommodated.

In such an embodiment of a high-pressure pump for delivering fuel in accordance with the principle of a cam mechanism, however, the problem arises that with the use of a compression spring element embodied in the form of a spiral spring, the compression of the compression spring element exerts a torsion on the roller shoe assembly, the cam follower guide, the pump piston, and therefore also the feeler element, i.e. the roller. This results in a tendency for torsion to occur in the roller shoe and the feeler element so that the linear contact between the feeler element and the cam geometry is not more closely assured. There are in fact known torsion-preventing devices for this purpose, which are embodied in the form of linear guides between the cam follower device and the pump piston, but frequently, it is not possible to achieve a sufficient degree of precision. Also, linear guides have a minimum play that is comparatively large so that the linear contact between the feeler element and the cam geometry does not remain assured even when these linear guides are provided. This situation leads to a premature wear on the high-pressure pump, which is not desirable in view of the required service life and reliability of the high-pressure pump.

It is also necessary to construct reciprocating mechanisms of this kind out of a small number of components and to assure a simple construction. Arrangements of torsion-minimized compression spring elements of types other than that of a simple spiral spring are frequently very complex and still fail to achieve the torsion-free compression of the spring region.

The object of the present invention, therefore, is to produce a high-pressure pump for delivering fuel for an internal combustion engine, which enables a torsion-free guidance of the cam follower device in order to achieve the linear contact between the feeler element and the cam geometry.

### DISCLOSURE OF THE INVENTION

This object is attained based on a high-pressure pump for delivering fuel for an internal combustion engine as recited in the preamble to claim 1 in connection with its defining characteristics. Advantageous modifications of the invention are contained in the dependent claims.

The invention includes the technical teaching that the at least one contact surface between the compression spring element and the cam follower device and/or the surface of the compression spring element abutting this cam follower device has a friction-minimized surface coating in order to achieve a torsion decoupling of the compression spring element.

The advantage of the embodiment according to the invention lies in a decoupling of the torsion movement of the compression spring element from the cam follower device. When a contact surface is provided with a friction-minimized surface coating, the torsion of the compression spring element that accompanies its compression cannot be transmitted to the cam follower device, so that the torsion of the compression spring element can no longer cause a torsion of the cam follower device and therefore a torsion of the feeler element on the cam geometry. The compression spring element is accommodated between the cylinder head and the cam follower guide so that one end of the compression spring element rests against a receiving contour in the cam follower guide. This receiving structure inside the cam follower guide constitutes the contact surface that is provided with the friction-minimized surface coating. This surface coating, however, can also be embodied on the compression spring element so that the surface of the compression spring element that abuts the cam follower guide has the friction-minimized surface coating.

According to an advantageous modification of the arrangement of the cam follower device includes a pressure disk element that the compression spring element is brought to rest against, with at least one flat surface of the pressure disk element constituting the contact surface with the friction-minimized surface coating. The pressure disk element is embodied as annular and has two opposing flat surfaces so that one flat surface abuts the contact surface in the cam follower guide and the other flat surface abuts the end of the compression spring element. To minimize the friction and therefore to decouple the torsion between the compression spring element and the cam follower guide, either the first flat surface, the opposing flat surface, or both flat surfaces of the pressure disk element can be provided with a friction-minimized surface coating. The compression disk element, however, can also be attached in a torsion-preventing fashion to one end of the compression spring element, thus allowing a definite sliding motion of the opposing flat surface of the pressure disk element in relation to the cam follower guide. If the compression spring element is compressed, then a torsion can be produced in the compression spring element, which is compensated for between the pressure disk element and the cam follower guide.

It is advantageous that the feeler element is embodied in the form of a roller element and the cam follower device is also equipped with a cam follower guide that has a roller shoe inserted into it on which the contact surface with the friction-minimized surface coating itself is embodied. This illustrates another possibility that the contact surface with the friction-minimized surface coating can be embodied both on the pressure disk element and on the cam follower guide itself; it is also possible for there to be a combination of the respective contact surfaces with their respective friction-minimized surface coatings. In this instance, it is in particular possible to take advantage of selecting different surface coatings that slide against each other, thus constituting a tribologically optimized friction pairing.

It is also advantageous for the compression spring element to have a spring washer element affixed to its end in a torsion-preventing fashion, which rests flat against the contact surface of the cam follower guide. The spring washer element can be attached to the compression spring element in an integrally joined fashion, in a form-locked fashion, or by means of fastening elements so that the spring washer element is likewise embodied in the form of a flat annular contour and constitutes an annular contact surface. The contact surface of the spring washer element abutting the contact surface of the cam follower guide is advantageously provided with the friction-minimized surface coating. An even more advantageous embodiment of the present invention includes a spring washer element situated at the end of the compression spring element as well as a pressure disk element so that the pressure disk element is situated between the spring washer element and the cam follower guide and abuts both the contact surface of the compression spring element and the contact surface of the spring washer element. According to the latter arrangement, four contact surfaces, each provided with a respective friction-minimized surface coating, can abut one another in a stacked arrangement, with the pressure disk element situated between the spring washer element and the cam follower guide.

The friction-minimized surface coating is advantageously applied to the at least one contact surface by means of a PVD method, a CVD method, a galvanic method, or a chemical method. It is also possible for the friction-minimized surface coating to include a sliding lacquer and/or a dry lubricant applied to the contact surface. The friction-minimized surface coating can also be a hard material coating such as a titanium oxide coating, a zirconium oxide coating, a silicon oxide coating, a titanium carbide coating, or a titanium nitrite coating. It is also possible to provide innovative PVD/hard material coatings such as TiMgN coatings. A combination of friction-minimized surface coatings and a surface layer treatment of the respective contact surface is another advantageous possibility within the scope of the present invention. Titanium carbide coatings, which feature a very high degree of hardness, paired with a low coefficient of friction and extremely high adhesion strength, are particularly advantageous. By contrast, titanium nitrite coatings feature a high degree of hardness, high durability, and a very low build-up tendency, making it possible to avoid the occurrence of fretting and coating buildup. Favorable corrosion and oxidation properties are also advantageous.

The cam follower device, which includes the compression spring element, is situated inside the pump body, which is filled with fuel. For this reason, the fuel can function as a lubricant so that the surface coating cooperates with the lubricating action of the fuel. For this reason, the surface coating should have a corresponding resistance to fuel, in particular diesel fuel. Another possible surface coating can be a titanium aluminum nitrite coating; another possible hard material coating is a chromium nitrite coating. These coatings particularly feature a very high chemical and thermal stability; the chromium nitrite coating in particular has a low adhesion tendency since the arrangement of the compression spring element operatively connected to the pressure disk element and/or the spring washer element can have high local surface pressures, so that a low adhesion tendency is advantageous.

A friction-minimized surface coating in the form of a monolayer can also be used; other possible variants include binary layers (Ti(C,N)), multilayer coatings (TiC/TiN), or graduated layers (TiC(TI(C,N)/TiN). The friction-minimized surface coating according to the invention is consequently not limited to a certain coating system, but rather encompasses several different coating systems.

In order to also be able to utilize the advantages of the embodiment of the friction-minimized surface coating according to the invention for other surfaces subjected to stress, it is possible within the scope of the present invention for the entire compression spring element, the entire cam follower guide, the entire pressure disk element, and the spring washer element to be completely covered with a surface coating. The cam follower guide in particular slides in a guide bore inside the pump body or the cylinder head so that it is also advantageous to provide the entire components with a coating.

Additional measures that improve the invention will be explained in greater detail below together with the description of a preferred exemplary embodiment of the invention in conjunction with the drawings.

### EXEMPLARY EMBODIMENTS

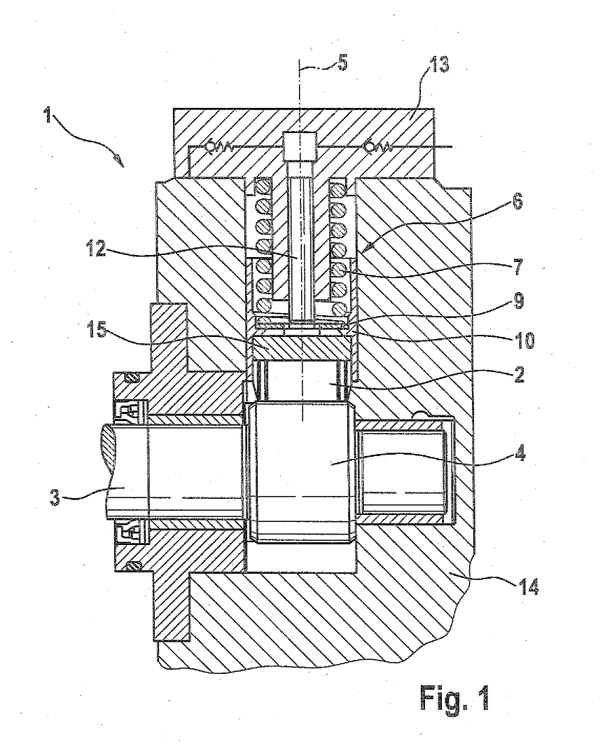

FIG. 1 is a cross-sectional view of a high-pressure pump with a cam follower device, a compression spring element, a cam follower guide with an inserted roller shoe, and a pressure disk element situated between the compression spring element and the cam follower guide;

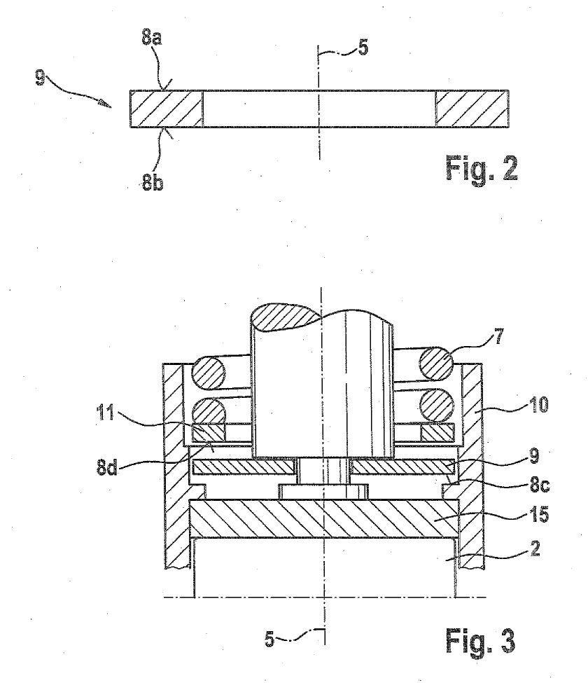

FIG. 2 is a cross-sectional view of the pressure disk element according to the invention, with a first and second contact surface; and

FIG. 3 is a cross-sectional view of the arrangement of the cam follower device with the respective contact surfaces according to the invention; the compression spring element, the pressure disk element, and a spring washer element are each shown in an arrangement in which they are detached from one another.

FIG. 1 is a cross-sectional side view of a high-pressure pump 1 of the kind used in common rail fuel injection systems for diesel engines. The high-pressure pump 1 is used to deliver diesel fuel, in order to supply the fuel at a high pressure to a common rail. The high-pressure pump 1 has a feeler element 2, which rolls along a cam geometry 4 situated on a cam shaft 3. The cam shaft 3 is driven by the engine and includes at least one cam geometry 4; this cam geometry includes one or more cams distributed uniformly around the circumference. As a result, the feeler element 2 executes a reciprocating motion in the direction of a stroke axis 5, and the reciprocating motion of the feeler element 2 is transmitted to a cam follower device 6. The cam follower device 6 includes a compression spring element 7 and a pump piston 12; the feeler element 2 is accommodated inside a cam follower guide 10, which, together with the roller shoe 15, is likewise a component of the cam follower device 6. Between the compression spring element 7 and the cam follower guide 10, there is a pressure disk element 9, which is embodied in the form of a flat washer and is shown in cross-section in the drawing. The pump piston 12 extends from the center of the roller shoe 10, is guided inside a cylinder head 13, and cooperates with a valve device in the cylinder head 13 in order to deliver the fuel. The high-pressure pump 1 essentially includes a pump body 14, with the cylinder head 13 being mounted onto the pump body 14 in a sealed fashion. Consequently, the pump body 14 and the cylinder head 13 constitute the guide device for the reciprocating motion of the cam follower device 6 in the direction of the stroke axis 5; a torsion-preventing device of the cam follower device 6 provided to prevent a torsion around the stroke axis 5 is not shown in detail.

FIG. 2 shows an enlarged depiction of the pressure disk element 9 that is situated between the compression spring element and the earn follower guide, see FIG. 1. The pressure disk element 9 includes a contact surface 8a according to the invention and on the opposite side, an additional contact surface 8b, which has a friction-minimized surface coating. The pressure disk element 9 extends in a ring shape around the stroke axis 5, allowing the pump piston to extend through the pressure disk element 9. The friction-minimized contact surfaces 8a and 8b respectively abut the compression spring element and the cam follower guide, so that either the first contact surface 8a or the second contact surface 8b or both contact surfaces have the friction-minimized surface coating according to the invention.

FIG. 3 shows a possible arrangement of a cam follower device 6 according to the invention, having a pressure disk element 9 situated between the cam follower guide 10 and a spring washer element 11, with the roller shoe 15 for accommodating the feeler element 2 being inserted in the cam follower guide 10. The spring washer element 11 is attached to the compression spring element 7, with the attachment to the compression spring element being produced either in an integrally joined fashion (welding, soldering, adhesive) or in a form-locked fashion (press-fitting, wedging, or caulking). The spring washer element 11 can include another contact surface 8d according to the invention, which likewise has a friction-minimized surface coating. In addition, the cam follower guide 10 has a contact surface 8c, which can also have a friction-minimized surface coating. According to FIG. 3, a pressure disk element 9 is inserted between the spring washer element 11 and the cam follower guide 10; the pressure disk element 9 can also be omitted so that the contact surface 8d of the spring washer element 11 directly abuts the contact surface 8c of the cam follower guide 10 and can slide against it.

The sliding motion in this case includes an oscillating rotating motion in small angular ranges since with each stroke of the roller shoe 15, a torsion of the compression spring element 7 occurs in relation to the cam follower guide 10. This torsion of the compression spring element 7 is compensated for between the contact surfaces 8a, 8b, 8c, and 8d since the contact surfaces are friction-minimized and permit a sliding motion in relation to, one another; the sliding motion produces minimal friction or no friction of any consequence in connection with the lubricating action of the fuel. Consequently, the torsion tendency of the compression spring element 7 is not transmitted to the cam follower guide 10 so that this rotary motion is likewise not transmitted to the feeler element 2 and as a result, the linear contact between the feeler element 2 and cam geometry 4 of the cam shaft 3 is maintained.

The embodiment of the invention is not limited to the preferred exemplary embodiment given above. There are instead a number of conceivable variants that make use of the approach mentioned above, even in embodiments that differ from it categorically in nature.

1-8. (canceled)

9. A high-pressure pump, in particular for delivering fuel for a common rail fuel injection system, including at least one cam mechanism with a feeler element, which a cam geometry provided on a cam shaft sets the feeler element into a reciprocating stroke motion in the direction of a stroke axis; the stroke motion being transmittable to a cam follower device; the compression spring element acting on the cam follower device and the feeler element with a force oriented toward the cam geometry, and the cam follower device having at least one contact surface that abuts the compression spring element, the at least one contact surface and/or the surface of the compression spring element abutting the contact surface having a friction-minimized surface coating in order to achieve a torsional decoupling of the compression spring element.

10. The high-pressure pump as recited in claim 9, wherein the cam follower device includes a pressure disk element that the compression spring element is brought into contact with and at least one flat surface of the pressure disk element constitutes the contact surface with the friction-minimized surface coating.

11. The high-pressure pump as recited in claim 9, wherein the feeler element is embodied in the form of a roller element and the cam follower device also includes a cam follower guide on which the contact surface with the friction-minimized surface coating is embodied.

12. The high-pressure pump as recited in claim 10, wherein the feeler element is embodied in the form of a roller element and the cam follower device also includes a cam follower guide on which the contact surface with the friction-minimized surface coating is embodied.

13. The high-pressure pump as recited in claim 11, wherein the compression spring element has a spring washer element affixed to its end in a torsion-preventing fashion, which rests flat against the contact surface of the cam follower guide.

14. The high-pressure pump as recited in claim 12, wherein the compression spring element has a spring washer element affixed to its end in a torsion-preventing fashion, which rests flat against the contact surface of the cam follower guide.

15. The high-pressure pump as recited in claim 11, wherein the contact surface of the spring washer element abutting the contact surface of the cam follower guide includes a friction-minimized surface coating.

16. The high-pressure pump as recited in claim 12, wherein the contact surface of the spring washer element abutting the contact surface of the cam follower guide includes a friction-minimized surface coating.

17. The high-pressure pump as recited in claim 13, wherein the contact surface of the spring washer element abutting the contact surface of the cam follower guide includes a friction-minimized surface coating.

18. The high-pressure pump as recited in claim 14, wherein the contact surface of the spring washer element abutting the contact surface of the cam follower guide includes a friction-minimized surface coating.

19. The high-pressure pump as recited in claim 13, wherein the pressure disk element is situated between the spring washer element and the cam follower guide so that the contact surface of the compression spring element abuts the contact surface.

20. The high-pressure pump as recited in claim 14, wherein the pressure disk element is situated between the spring washer element and the cam follower guide so that the contact surface of the compression spring element abuts the contact surface.

21. The high-pressure pump as recited in claim 15, wherein the pressure disk element is situated between the spring washer element and the cam follower guide so that the contact surface of the compression spring element abuts the contact surface.

22. The high-pressure pump as recited in claim 18, wherein the pressure disk element is situated between the spring washer element and the cam follower guide so that the contact surface of the compression spring element abuts the contact surface.

23. The high-pressure pump as recited in claim 9, wherein the friction-minimized surface coating is applied to the at least one contact surface by means of a PVD method, a CVD method, a galvanic method, or a chemical method.

24. The high-pressure pump as recited in claim 13, wherein the friction-minimized surface coating is applied to the at least one contact surface by means of a PVD method, a CVD method, a galvanic method, or a chemical method.

25. The high-pressure pump as recited in claim 22, wherein the friction-minimized surface coating is applied to the at least one contact surface by means of a PVD method, a CVD method, a galvanic method, or a chemical method.

26. The high-pressure pump as recited in claim 9, wherein the friction-minimized surface coating includes a sliding lacquer and/or a dry lubricant applied to the contact surface.

27. The high-pressure pump as recited in claim 11, wherein the friction-minimized surface coating includes a sliding lacquer and/or a dry lubricant applied to the contact surface.

28. The high-pressure pump as recited in claim 25, wherein the friction-minimized surface coating includes a sliding lacquer and/or a dry lubricant applied to the contact surface.
